(19) United States
(12) Patent Application Publication
(10) Pub. No.: US 2026/0267477 A1
(43) Pub. Date: Sep. 10, 2026

(54) METHOD, APPARATUS, DEVICE, AND STORAGE MEDIUM FOR PAGE INTERACTION

(71) Applicant: Beijing Zitiao Network Technology Co., Ltd., Beijing (CN)

(72) Inventors: Lei WANG, Beijing (CN); Wei ZHANG, Beijing (CN)

(21) Appl. No.: 19/164,731

(22) PCT Filed: Aug. 15, 2024
(86) PCT No.: PCT/CN2024/112249

§ 371 Date: Sep. 12, 2025

(30) Foreign Application Priority Data
Oct. 19, 2023 (CN) 202311358575.6

(51) Int. Cl. G06F 3/0483

(52) U.S. Cl. CPC G06F 3/0483

(57) ABSTRACT

According to embodiments of the present disclosure, a method, an apparatus, a device, and a computer-readable storage medium for page interaction are provided. In the method, a content display page is presented, the content display page at least presenting a media content item, and the content display page being enabled to be presented at least by selecting a predetermined navigation tab; in response to detecting a trigger for the navigation tab, an operation panel in the content display page is provided, the operation panel comprising a plurality of operation options for triggering a plurality of types of service functions for the content display page, each type of service function having at least one operation option in the operation panel; and a service function corresponding to the operation option is triggered in the content display page, in response to detecting a selection for an operation option among the plurality of operation options.

The present application claims priority to Chinese Patent Application No. 2023113585756, filed on Oct. 19, 2023, and entitled “METHOD, APPARATUS, DEVICE, AND STORAGE MEDIUM FOR PAGE INTERACTION”, the entire content of which is incorporated herein by reference.

### FIELD

Example embodiments of the present disclosure generally relate to the field of computers, and in particular to a method, an apparatus, a device, and a computer-readable storage medium for content presentation.

### BACKGROUND

Currently, more and more applications are designed to provide various services for users. For example, the users may post, browse, and view various types of content in the applications, including multimedia content such as videos, images, image sets, and sounds. The users may also interact with other users in the applications, for example, by liking, favoriting, or commenting on the content posted by other users, or by following other users or visiting personal homepages of other users.

### SUMMARY

In a first aspect of the present disclosure, a method for page interaction is provided. The method includes: presenting a content display page, the content display page at least presenting a media content item, and the content display page being enabled to be presented at least by selecting a predetermined navigation tab; providing, in response to detecting a trigger for the navigation tab, an operation panel in the content display page, the operation panel including a plurality of operation options for triggering a plurality of types of service functions for the content display page, each type of service function having at least one operation option in the operation panel; and triggering, in the content display page, a service function corresponding to the operation option in response to detecting a selection for an operation option among the plurality of operation options ..

In a second aspect of the present disclosure, an apparatus for page interaction is provided. The apparatus includes: a page presenting module, configured to present a content display page, the content display page at least presenting a media content item, and the content display page being enabled to be presented at least by selecting a predetermined navigation tab; a panel providing module, configured to provide, in response to detecting a trigger for the navigation tab, an operation panel in the content display page, the operation panel including a plurality of operation options for triggering a plurality of types of service functions for the content display page, each type of service function having at least one operation option in the operation panel; and a function triggering module, configured to trigger, in the content display page, a service function corresponding to the operation option in response to detecting a selection for an operation option among the plurality of operation options.

In a third aspect of the present disclosure, an electronic device is provided. The device includes at least one processing unit; and at least one memory coupled to the at least one processing unit and storing instructions executable by the at least one processing unit, the instructions, when executed by the at least one processing unit, causing the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, a computer program product is provided. The computer program product includes a computer program that, the computer program, when executed by a processor, implements the method according to the first aspect of the present disclosure.

It should be understood that the summary described in this disclosure is not intended to limit key features or important features of implementations in the present disclosure, nor is it intended to limit the scope in the present disclosure. Other features in the present disclosure will become readily understood from the following description.

### BRIEF DESCRIPTION OF THE DRAWINGS

The above and other features, advantages, and aspects of the various embodiments in the present disclosure will become more apparent from the following detailed description taken in combination with the accompanying drawings. In the drawings, the same or similar reference numbers refer to the same or similar elements, where:

FIG. 1 illustrates a schematic diagram of an example environment in which embodiments of the present disclosure may be implemented;

FIGS. 2A to 2B illustrate examples of content display pages according to some embodiments of the present disclosure;

FIGS. 3A to 3E illustrate schematic diagrams of switching content recommendation modes according to some embodiments of the present disclosure;

FIGS. 4A to 4B illustrate schematic diagrams of switching view modes according to some embodiments of the present disclosure;

FIGS. 5A to 5B illustrate schematic diagrams of triggering instructions according to some embodiments of the present disclosure;

FIG. 6 illustrates a flowchart of a process of page interaction according to some embodiments of the present disclosure;

FIG. 7 illustrates a block diagram of an apparatus for page interaction according to some embodiments of the present disclosure; and

FIG. 8 illustrates a block diagram of an electronic device in which one or more embodiments of the present disclosure may be implemented.

### DETAILED DESCRIPTION OF EMBODIMENTS

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

Herein, unless expressly stated herein, performing a step “in response to A” does not mean that the step is performed immediately after “A”, but may include one or more intermediate steps.

It would be appreciated that the data involved in this technical solution (including but not limited to the data itself, data acquisition or use) shall comply with the requirements of corresponding laws, regulations and relevant provisions.

It would be appreciated that before the technical solution disclosed in the embodiments in the present disclosure is used, users should be informed of the type, the scope of use, the use scenario, etc. of the personal information involved in the present disclosure in an appropriate manner and in accordance with relevant laws and regulations, and the authorization of the relevant users may be obtained.

For example, in response to an active request being received from a user, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution in the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It would be appreciated that the above process of notification and acquisition of user authorization is only illustrative and do not limit the implementations in the present disclosure. Other methods that meet relevant laws and regulations may also be applied to the implementations in the present disclosure.

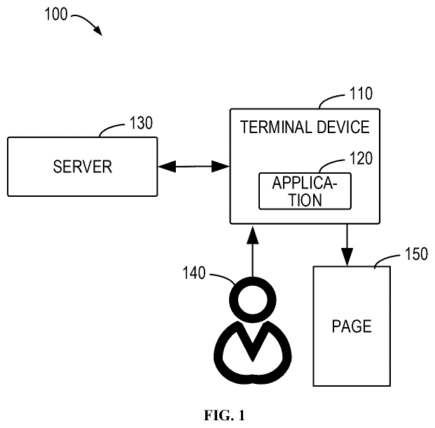

FIG. 1 illustrates a schematic diagram of an example environment in which embodiments of the present disclosure may be implemented. In this example environment 100, an application 120 is installed in a terminal device 110. A user 140 may interact with the application 120 via the terminal device 110 and/or an attachment device of the terminal device 110.

In some embodiments, the application 120 may be a content sharing application (for example, a video application mainly sharing videos), which may provide the user 140 with various services related to media content items, including content browsing, commenting, reposting, creating (for example, shooting and/or editing), posting, and so on. In some embodiments, the application 120 may also be any other appropriate application in which media content items may be displayed. As used herein, each “media content item” includes one or more types of content, such as videos, images, animated images, image sets, audio, text, and so on.

In the environment 100 of FIG. 1, if the application 120 is in active state, the terminal device 110 may present a page 150 of the application 120. The page 150 may include various types of pages that may be provided by the application 120, such as a content presentation page, a content creation page, a content posting page, a message page, a personal homepage, and so on. The application 120 may provide a content viewing function to view various types of content posted in the application 120. Via corresponding pages, the application 120 may provide the user 140 with content associated with media content or shopping content. Via an appropriate approach, such as clicking or selecting a page element, the application 120 may also provide the user 140 with a selection and switching of presentation approaches of the associated content. As used herein, “media content” includes one or more types of content, such as images, image sets, videos, animated images, audio, text, and so on.

In some embodiments, the terminal device 110 communicates with a server 130 to enable provision of the services of the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including the accessories and peripherals of these devices or any combination thereof. In some embodiments, the terminal device 110 may also support any type of user-specific interface (such as “wearable” circuit, etc.). The server 130 may be various types of computing systems/servers capable of providing computing power, including but not limited to mainframes, edge computing nodes, computing devices in cloud environments, and so on.

It should be understood that the structures and functions of the elements in the environment 100 are described for illustrative purposes only, without suggesting any limitation to the scope of the present disclosure.

In the process of browsing content on an application page, different users may need to trigger different service functions of the application in different scenarios. In application design, different types of functions are usually designed according to a certain page hierarchy structure, and are located by users through relatively long or short click paths. This increases the operation complexity for the users, causes users to spend more time in triggering functions, and also affects immersion of users in the content being browsed.

According to embodiments of the present disclosure, an improved page interaction solution is proposed. According to the solution in the embodiments of the present disclosure, in a content display page for presenting a media content item, an operation panel including a plurality of operation options is provided by triggering a navigation tab corresponding to the content display page. The plurality of operation options are configured to trigger a plurality of types of service functions for the content display page, each type of service function having at least one operation option in the operation panel. If a selection for a certain operation option in the operation panel is detected, a service function corresponding to the operation option is triggered in the content display page. In this way, by operating the navigation tab of the page, a set of options for a plurality of types of functions may be provided for user selection, so as to enable users to quickly locate a function to be triggered, making the operation of the users more convenient and the user experience better.

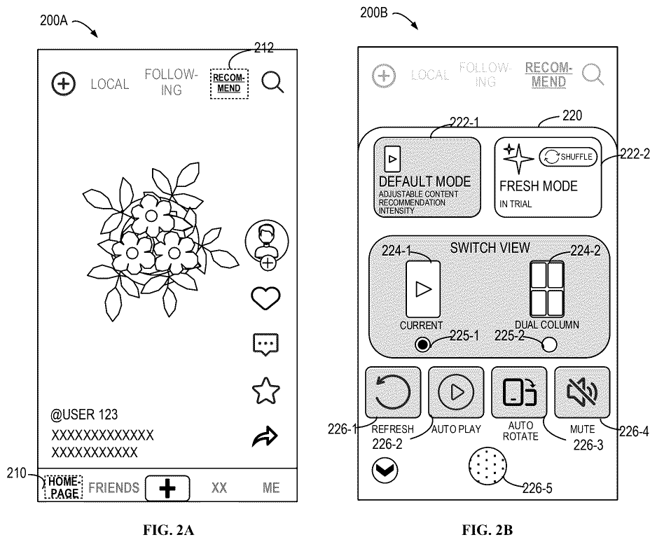

Some example embodiments of the present disclosure will be further described below with reference to the drawings. The pages shown in FIGS. 2A to 5B may be presented by the terminal device 110. For the convenience of discussion, these embodiments will be described with reference to the environment 100 of FIG. 1.

It should be understood that the pages shown in the drawings are only examples, and various page designs may exist. Various graphic elements in the page may have different arrangements and different visual representations, one or more of the elements may be omitted or replaced, and there may also be one or more other elements. The embodiments of the present disclosure are not limited in this regard.

In the environment 100, the terminal device 110 presents a page 150 of the application 120. In some cases, the page 150 presented by the terminal device 110 may be a specific content display page of the application 120, with a media content item presented in the content display page. In some embodiments, the content display page refers to a page for displaying or pushing media content items and other related information to users. A set of media content items that can be presented in the content display page may include various types of media content items. The media content item to be presented in the specific content display page may be determined according to application design requirements. The specific media content item to be displayed and the number thereof will vary in different scenarios.

In some embodiments, the content display page may include a homepage of the application 120, or a recommended homepage in a set of homepage pages of the application 120. The recommended content item displayed to the user in the recommended homepage is sometimes also referred to as a recommended information flow. In some embodiments, the content display page may include other pages under the homepage of the application 120, such as a following page (in which media content items posted by a group of users followed by the current user are displayed), a local page (in which media content items posted by other users located within a same area range as the current user are displayed), or media content items aggregated or categorized in other ways.

When a large amount of information needs to be presented in an application and the information is complex, the information is often presented in different categories to facilitate the users to obtain the information in a more concise manner. Presenting the information in different categories often requires setting a plurality of navigation tabs corresponding to different information on the page. The users may obtain the page corresponding to a tab by switching to different navigation tabs. In some embodiments, the application 120 may provide navigation tabs for navigating to different pages. In the embodiments of the present disclosure, a page, including the content display page, may be presented at least by selecting a predetermined navigation tab. That is, the predetermined navigation tab in the application may be configured to navigate to the content display page.

FIGS. 2A to 2B illustrate examples of content display pages according to some embodiments of the present disclosure. As shown in FIG. 2A, the current page of the application 120 provides a plurality of navigation tabs for navigating to various pages, such as “local”, “following”, “recommend”, “homepage”, “friends”, and so on. The plurality of navigation tabs may also have different levels, for example, the navigation tabs “homepage” and “friends” may be at a first level, and the navigation tabs “local”, “following”, and “recommend” may be at a second level. The first-level navigation tab may correspond to, for example, a set of pages (for example, a set of homepage pages), and the page corresponding to the second-level navigation tab may be, for example, at least one of the set of pages corresponding to the first-level navigation tab (for example, the recommended homepage corresponding to the navigation tab “recommend” is one of the set of homepage pages corresponding to the navigation tab “homepage”).

In the embodiments of the present disclosure, the terminal device 110 presents a specific content display page, such as a specific content display page of the application 120. For example, in the example 200A shown in FIG. 2A, the navigation tab 210 is the tab “homepage”. If the terminal device 110 detects a selection for the navigation tab 210, the homepage of the application as shown in FIG. 2A may be presented. For example, the terminal device 110 may present the recommended homepage (that is, the page corresponding to the navigation tab “recommend” 212) in a plurality of homepages by default. On this basis, if the terminal device 110 detects a trigger for the navigation tab “following”, it may switch to presenting the following homepage (that is, the page corresponding to the navigation tab “follow”) in the plurality of homepages. It should be understood that this is only illustrative and is not intended to limit the solution of the present disclosure. In some embodiments, alternatively or additionally, the content display page presented by the terminal device 110 may also be automatically presented by detecting a start operation of the application 120, for example, the content display page is a default page presented when the application is started. That is, in the absence of user selection of the navigation tab, the content display page may be the default page after the application 120 is launched.

In the example 200A of FIG. 2A, the navigation tab 210 corresponding to the current content display page is the tab “homepage”. The “recommend” page may be presented by selecting this navigation tab. It should be understood that this is only illustrative and is not intended to limit the solution of the present disclosure. In order to trigger the operation panel by means of an existing navigation tab, the navigation tab may be another tab that supports navigation to the content display page, for example, the tab “recommend” in FIG. 2A. In some embodiments, alternatively or additionally, the content display page may also be presented by detecting a start operation of the application. For example, the content display page is a default page presented when the application is started. In accordance with being presented after the application startup, a first set of media content items may be presented in a first view mode in the content display page.

In the embodiments of the present disclosure, while the specific content display page is presented, if the terminal device 110 detects a preset trigger for the navigation tab, the operation panel is provided in the content display page. The operation panel includes a plurality of operation options for triggering a plurality of types of service functions for the content display page, each type of service function having at least one operation option in the operation panel.

In the embodiments of the present disclosure, the content display page may also be used to trigger the provision of an operation panel including a plurality of types of service functions. In some embodiments, the preset trigger operation for triggering the provision of the operation panel may include a trigger for the navigation tab. The trigger includes, but is not limited to, a single-click, a double-click, a long-press for the navigation tab. In some embodiments, alternatively or additionally, the preset trigger may further include other trigger for the content display page (for example, a long-press on the content display page, etc.). The present disclosure does not limit the specific preset trigger, and the terminal device 110 may provide the operation panel in the active layer of the content display page in response to detecting any appropriate preset trigger.

The operation panel presented in the content display page may provide the user with a plurality of operation options for triggering a plurality of types of service functions for the content display page, each type of service function having at least one operation option in the operation panel. That is, the operation panel inherits a plurality of types of functions that may be operated on the content display page, such as a function of operating the presentation of the media content item in the content display page. The user may conveniently select the operation option under each service function via the operation panel, thereby triggering the corresponding service function. Such an operation panel may be regarded as a “remote controller” for the content display page, which is convenient for the user to control the content display page.

In some embodiments, the provided operation panel may include an operation option corresponding to a content recommendation switching function, including a plurality of operation options corresponding to a plurality of content recommendation modes, respectively. Each content recommendation mode corresponds to a respective content recommendation strategy in the content display page. By providing a plurality of operation options respectively corresponding to a plurality of content recommendation modes, the user may be allowed to select the specific content to be viewed in the content display page. By selecting a desired content recommendation mode, the media content item presented in the content display page may be loaded according to the content recommendation strategy in that mode. FIG. 2B shows an example 200B of a content display page provided with an operation panel 220. The operation panel 220 may be provided by a trigger (for example, a click) on the tab “homepage” in the content display page shown in FIG. 2A. In the operation panel 220, an operation option 222-1 corresponding to a “default mode” and an operation option 222-2 corresponding to a “fresh mode” are provided, where the “default mode” and the “fresh mode” correspond to two content recommendation modes, respectively.

In some embodiments, the provided operation panel may include an operation option corresponding to a view switching function, including a plurality of operation options respectively corresponding to a plurality of view modes. Each view mode corresponds to a presentation view of the media content item in the content display page. The plurality of view modes may include, for example, at least a single-column view mode and at least one multi-column view mode (including but not limited to a dual-column view mode, a three-column view mode, etc.). The single-column view mode may reduce the cost of thinking and selection for the user, and the at least one multi-column view mode facilitates the user to explore more content of interest. Providing a variety of view modes may facilitate the user to compare the difference between the single-column view mode and the at least one multi-column view mode, and then select or switch according to preferences. In the example of FIG. 2B, the operation panel 220 includes an operation option 224-1 corresponding to the single-column view mode and an operation option 224-2 corresponding to the dual-column view mode.

In some embodiments, alternatively or additionally, the provided operation panel may further include at least one instruction for a media content control function, for controlling the presentation of the media content item. These instructions are instructions that the user may operate and select in the content display page.

In some embodiments, the operation panel may include a content refresh instruction for the content display page, for refreshing the media content item displayed in the content display page. The operation option 226-1 in the example of FIG. 2B corresponds to the content refresh instruction.

Alternatively or additionally, the operation panel may include at least one playback control instruction for controlling the playback of the media content item. Such a playback control instruction may include an auto play instruction for enabling or disabling playing a series of media content items in sequence in the content display page. Alternatively or additionally, the playback control instruction may include an auto rotate instruction for enabling or disabling an auto rotate function of a playback interface of the media content item. Auto rotate refers to automatic maintenance of landscape display of the playback interface when a screen of a terminal device is rotated. In some embodiments, alternatively or additionally, the playback control instruction may include a mute instruction for canceling or enabling mute playback of the media content item having audio. The operation options 226-2, 226-3, and 226-4 in the example of FIG. 2B correspond to the auto play instruction, the auto rotate instruction, and the mute instruction, respectively.

In some embodiments, alternatively or additionally, the operation panel may include an instruction for triggering voice instruction input. By triggering this instruction, a voice assistant of the application 120 may be activated to receive voice instructions from the user and interact with the user through voice. The operation option 226-5 in the example of FIG. 2B corresponds to the instruction for triggering voice instruction input.

The above are only examples of content recommendation modes, view modes, and instructions. In an example application, more, fewer, or other content recommendation modes, view modes, and instructions may be provided according to specific needs. In some embodiments, the operation options presented in the content display page may be changed based on one or more factors. For example, the operation options presented in the content display page may be changed based on the type of the content display page, a specific date or time, a usage need of a user group, and/or a popularity of the usage of the users for the content recommendation mode, the view mode, and/or the instructions, etc. For example, the at least one instruction provided in the operation panel may be selected from an instruction set based on a popularity of the use of each instruction in the instruction set of the content display page. In this way, the user may be provided with instructions in the operation panel that the user has a higher probability of selecting.

In some embodiments, if the operation panel is triggered, the operation panel is provided in the active layer of the content display page. In the case that the operation panel is provided, the media content item in the content display page may be presented in the background layer of the content display page. In the embodiments of the present disclosure, the background layer of the page refers to page content that is not currently directly operable by the user, and the active layer of the page refers to page content that is currently directly operable by the user. Therefore, the operation panel in the active layer is an area that is directly operable by the user, allowing the user to perform corresponding operations on interface elements such as options and controls provided by the operation panel, especially to flexibly switch the view mode. The media content item in the background layer is not currently directly operable by the user.

In some embodiments, in order to better distinguish the active layer from the background layer for improving the visual experience of the user, the terminal device 110 may further superimpose a overlay on the media content item in the background layer of the content display page. The overlay may be a semi-transparent or transparent superimposed layer, so that the media content item is still visible to the user. As shown in FIG. 2B, the terminal device 110 may superimpose a semi-transparent overlay on the media content item 220 in the background layer of the content display page. In some embodiments, before the operation panel is cancelled to be presented, the overlay superimposed in the background layer may always be presented.

In some embodiments, when the operation panel is provided, the state of the operation option in the operation panel may be presented to indicate the state of the corresponding service function. For example, before the preset trigger for triggering the presentation of the operation panel is detected, the terminal device 110 may present the media content item in a certain view mode and/or a certain content recommendation mode in the content display page. After the preset trigger operation is detected, the terminal device 110 may present the state of the operation option corresponding to the current view mode and/or content recommendation mode as a selected state in the operation panel, and present the states of other operation options as unselected states. For operation options corresponding to other types of service functions, their states may also be indicated by corresponding state identifications.

As shown in FIG. 2B, if the terminal device 110 presents the media content item in the single-column view mode before the preset trigger, the state indicator 225-1 corresponding to the single-column view mode is presented as a selected state after the operation panel 220 is triggered to be presented. The terminal device 110 may identify the state of the operation option by, for example, highlighting the operation option, adding a border to the operation option, enlarging the size of the operation option, adding text to the operation option, providing different interface elements for the operation option, etc. For example, if the “default mode” is determined by the terminal device 110 as the content recommendation mode in the content display page before the preset trigger, the appearance style of the operation option 222-1 corresponding to the “default mode” is presented to indicate the selected state after the operation panel 220 is triggered to be presented. For the operation options 226-1 to 226-5, a similar or different approach may be determined to indicate the states of the service functions (for example, the service functions are enabled or disabled) corresponding to these operation options.

While the operation panel is presented, in response to detecting a selection for an operation option among the plurality of operation options, a service function corresponding to the operation option is triggered in the content display page. In this way, by operating the navigation tab of the page, a set of options for a plurality of types of functions may be provided for user selection, so as to enable users to quickly locate a function to be triggered, making the operation of the users more convenient and the user experience better.

In some embodiments, for the content recommendation function, if a selection for an operation option corresponding to a first content recommendation mode in the plurality of content recommendation modes is detected in the operation panel, a media content item presented in the content display page is loaded according to the first content recommendation mode. Depending on the selection of the user, the recommended media content item may be provided to the user in the content display page according to different content recommendation strategies.

In some embodiments, if the selected first content recommendation mode is a predetermined content recommendation mode, an animation corresponding to the predetermined content recommendation mode is presented in the content display page in response to detecting the selection for the operation option corresponding to the first content recommendation mode, the animation at least indicating a switching process from a current content recommendation mode to the first content recommendation mode. That is, a corresponding switching animation effect may be configured for one or more content recommendation modes. When the content recommendation mode is selected, a pre-configured animation may be presented to indicate the change of the content recommendation strategy to the user with a visual effect.

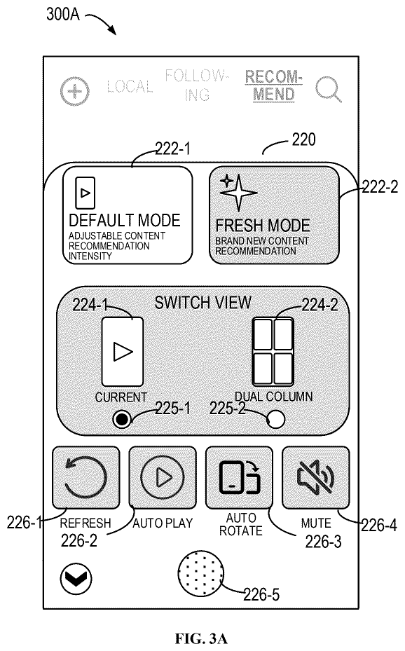

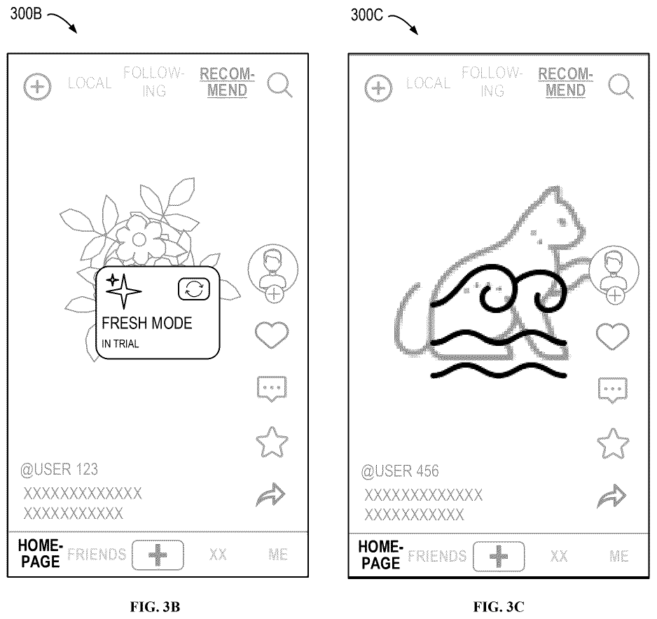

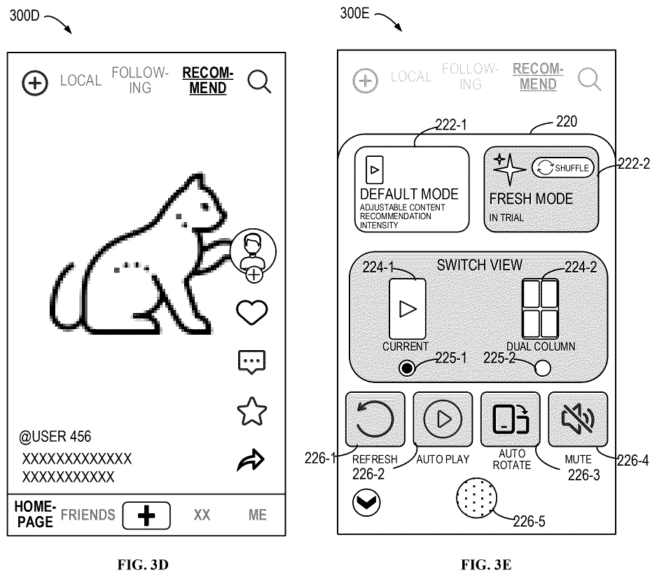

FIGS. 3A to 3E illustrate schematic diagrams of switching content recommendation modes according to some embodiments of the present disclosure. It is assumed that the previous content recommendation mode in the content display page is the “default mode”, and in the example 300A of FIG. 3A, the “fresh mode” corresponding to the operation option 222-2 is selected based on the selection of the user for the operation option 222-2. In this way, the animation effect shown in the example 300B of FIG. 3B and the example 300C of FIG. 3C may be provided in the content display page until the example 300D of FIG. 3D. In the example 300D, the media content item loaded according to the “fresh mode” is presented in the content display page. In some embodiments, when the “fresh mode” is selected, the presented animation may include: collecting all interface elements in the operation panel into the card corresponding to the “fresh mode”, then the card continues to be loaded. After loading for a period of time, new content is refreshed through animation of water wave diffusion, so as to indicate an effect of brand-new content to the user. This is only a specific example, and various animations may be configured according to actual applications and needs.

In some embodiments, in response to detecting the selection for the operation option corresponding to the first content recommendation mode, the terminal device 110 cancels the presentation of the operation panel in the content display page. That is, after a certain content recommendation mode is selected, the operation panel is directly folded up, and the media content is recommended to the user in the content display page according to the selected content recommendation mode. For example, after the operation option corresponding to the “fresh mode” is selected in FIG. 3B, after presenting a clip of animation, the operation panel 240 is folded up and the ac media content item loaded cording to the “fresh mode” is automatically presented in the content display page of FIG. 3D.

Alternatively, in some embodiments, in response to detecting the selection operation for the operation option corresponding to the first content recommendation mode, the terminal device 110 may also continue to maintain the presentation of the operation panel in the content display page until a specific cancel presentation operation for the operation panel is received. For example, after the operation option corresponding to the “fresh mode” is selected in FIG. 3B, and after presenting a clip of animation, the operation panel 240 may still be presented, e.g., still in the active layer of the content display page for the user to continue to select.

In some embodiments, after the operation option corresponding to the “fresh mode” is selected and a new media content item is loaded in the content display page according to the content recommendation mode, if the operation panel is triggered to be presented again, the operation option corresponding to the “fresh mode” will be presented as a selected state, as shown in example 300E of FIG. 3E. In the operation panel presented this time, another content recommendation mode, for example, the operation option 222-1 corresponding to the “default mode” is presented as an unselected state.

In some embodiments, in response to detecting a selection for an operation option corresponding to a first view mode in the plurality of view modes, the terminal device 110 presents the media content item in the content display page in the first view mode while maintaining the presentation of the operation panel in the content display page. In some embodiments, in the case that the option corresponding to a certain view mode is selected, the media content item may be presented in the view mode corresponding to the operation option in the background layer of the content display page. That is, a preview of the view mode selected by the user is provided in the content display page. Regarding a specific switching approach in which the terminal device 110 switches the view mode to the first view mode corresponding to the first option to present the media content item, in some embodiments, the terminal device 110 may switch the view mode of the media content item by presenting a transition animation.

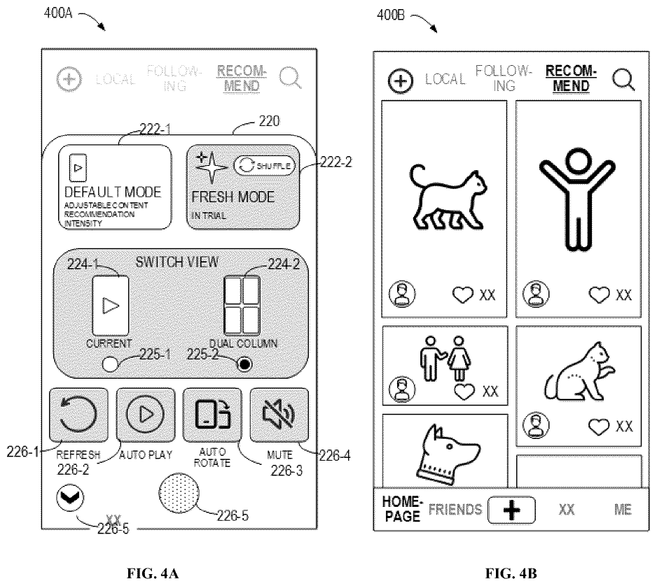

FIGS. 4A to 4B illustrate schematic diagrams of switching view modes according to some embodiments of the present disclosure. It is assumed that the previous view mode in the content display page is the single-column view mode, and in the example 400A of FIG. 4A, based on the user's selection for the operation option 224-2, the dual-column view mode corresponding to the operation option 224-2 is selected.

In some embodiments, the operation panel in the content display page does not completely cover the media content item, so that the preview of the media content item presented in the corresponding view would not be completely covered by the operation panel, allowing the user to see the preview effect of the selected view mode. In some embodiments, the operation panel and the media content item may be presented in different areas of the content display page, so that the operation panel will not cover the media content item. In some embodiments, additionally or alternatively, the operation panel may be provided in a transparent or semi-transparent style, which may allow the user to view the media content item in the background layer even if the operation panel partially or completely covers the media content item.

In some embodiments, if the selection for the operation option corresponding to the first view mode is detected, the terminal device 110, while maintaining the presentation of the operation panel in the active layer, may also present the state of the operation option corresponding to the first view mode as a selected state, and present operation options corresponding to other view modes as an unselected state, as shown in FIG. 4A.

In some embodiments, in the case that the operation option corresponding to a certain view mode is in the selected state, if a cancel presentation operation for the operation panel is detected, the terminal device 110 may cancel the presentation of the operation panel in the content display page, and cause the media content item in the content display page to be presented in the active layer of the content display page in the selected view mode. The cancel presentation operation here includes, but is not limited to, a selection for a collapse control for collapsing the operation panel, a selection for a cancel control, and a touch for any other appropriate area outside the operation panel in the content display page, etc. For ease of understanding, in the case that the operation panel is presented, the presentation effect of the media content item presented in the first view mode in the background layer by the terminal device 110 may be regarded as the preview effect of the final presentation effect. The terminal device 110 may determine that the confirmation for the preview effect is received in response to detecting the cancel presentation operation for the operation panel, and present the media content item in the first view mode indicated by the preview effect. For example, in the case that the dual-column view mode in FIG. 4A is selected, if the operation panel 220 is collapsed, the media content item in the content display page is presented in the dual-column view mode in the example 400B of FIG. 4B.

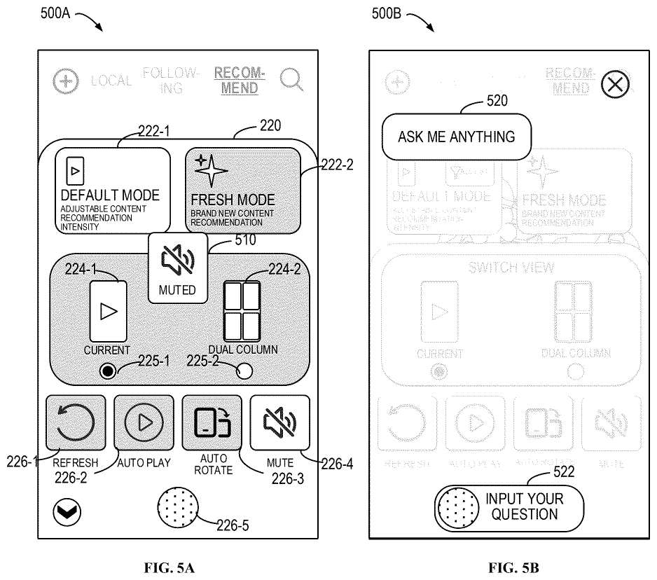

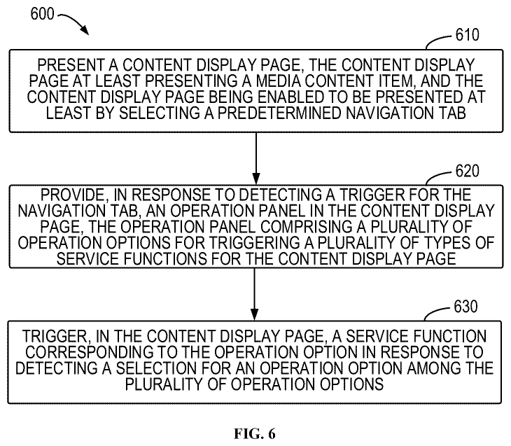

In the operation panel, in addition to switching the content recommendation strategy and the content view by selecting the operation option corresponding to the content recommendation mode and the view mode, the trigger for other instructions may also trigger the service function corresponding to the instruction. FIGS. 5A to 5B illustrate schematic diagrams of triggering instructions according to some embodiments of the present disclosure. In the example 500A of FIG. 5A, if a trigger for the operation option 226-4 of the mute instruction is detected, a mute startup prompt 510 is provided to prompt the user that the mute playback function of the media content item has been enabled. In the example 500B of FIG. 5B, if a trigger for the operation option 226-5 is detected, a panel for voice interaction is presented, which may include voice input prompts 520 and 522 to prompt the user to input voice instructions.

In some embodiments, after the trigger for these instructions is detected, the presentation of the operation panel may be maintained or the presentation of the operation panel may be directly cancelled. The embodiments of the present disclosure are not limited in this aspect.

FIG. 6 illustrates a flowchart of a process 600 for page interaction according to some embodiments of the present disclosure. The process 600 may be implemented at terminal device 110. Process 600 is described below with reference to FIG. 1.

At block 610, the terminal device 110 presents a content display page, the content display page at least presenting a media content item, and the content display page being enabled to be presented at least by selecting a predetermined navigation tab.

At block 620, the terminal device 110 provides, in response to detecting a trigger for the navigation tab, an operation panel in the content display page, the operation panel including a plurality of operation options for triggering a plurality of types of service functions for the content display page, each type of service function having at least one operation option in the operation panel.

At block 630, the terminal device 110 triggers, in the content display page, a service function corresponding to the operation option in response to detecting a selection for an operation option among the plurality of operation options.

In some embodiments, providing the operation panel in the content display page includes: providing the operation panel in an active layer of the content display page, the media content item being presented in a background layer of the content display page.

In some embodiments, an overlay is superimposed on the media content item presented in the background layer of the content display page.

In some embodiments, the plurality of operation options at least corresponds to two or more of the following: a plurality of content recommendation modes, a plurality of view modes, and at least one instruction for controlling presentation of the media content item.

In some embodiments, triggering, in the content display page, the service function corresponding to the operation option includes: in response to detecting a selection operation for an operation option corresponding to a first content recommendation mode in the plurality of content recommendation modes, loading a media content item presented in the content display page according to the first content recommendation mode.

In some embodiments, the process 600 further includes: in accordance with the selected first content recommendation mode being a predetermined content recommendation mode, presenting an animation corresponding to the predetermined content recommendation mode in the content display page in response to detecting the selection for the operation option corresponding to the first content recommendation mode, the animation at least indicating a switching process from a current content recommendation mode to the first content recommendation mode.

In some embodiments, the process 600 further includes: canceling presentation of the operation panel in the content display page in response to detecting the selection for the operation option corresponding to the first content recommendation mode.

In some embodiments, triggering, in the content display page, the service function corresponding to the operation option includes: presenting, in response to detecting a selection for an operation option corresponding to a first view mode in the plurality of view modes, the media content item in the content display page in the first view mode, while maintaining the presentation of the operation panel in the content display page.

In some embodiments, the at least one instruction includes at least one of: a content refresh instruction for the content display page, at least one playback control instruction for controlling playback of the media content item, or an instruction triggering voice instruction input.

In some embodiments, the content display page includes a homepage of an application.

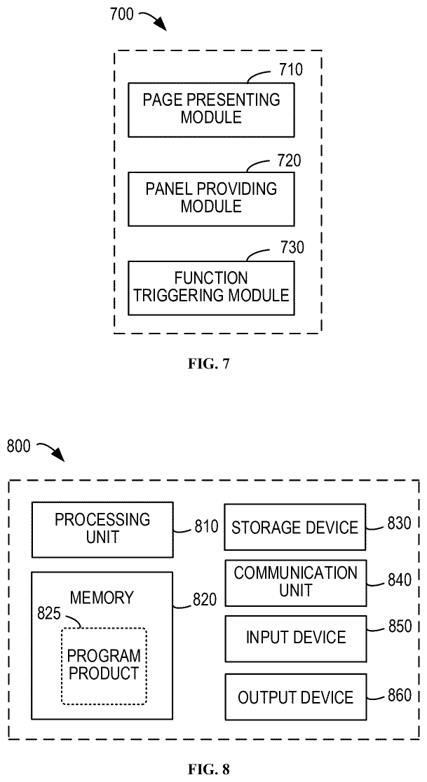

FIG. 7 illustrates a schematic structural block diagram of an apparatus 700 for page interaction according to some embodiments of the present disclosure. The apparatus 700 may be implemented as or included in the terminal device 110. Each module/component in the apparatus 700 may be implemented by hardware, software, firmware, or any combination thereof.

As shown in the figure, the apparatus 700 includes a page presenting module 710, configured to present a content display page, the content display page at least presenting a media content item, and the content display page being enabled to be presented at least by selecting a predetermined navigation tab. The apparatus 700 further includes a panel providing module 720 configured to provide, in response to detecting a trigger for the navigation tab, an operation panel in the content display page, the operation panel including a plurality of operation options for triggering a plurality of types of service functions for the content display page, each type of service function having at least one operation option in the operation panel. The apparatus 700 further includes a function triggering module 730 configured to trigger, in the content display page, a service function corresponding to the operation option in response to detecting a selection for an operation option among the plurality of operation options.

In some embodiments, the panel providing module 720 is further configured to: provide the operation panel in an active layer of the content display page, the media content item being presented in a background layer of the content display page.

In some embodiments, an overlay is superimposed on the media content item presented in the background layer of the content display page.

In some embodiments, the plurality of operation options at least corresponds to two or more of the following: a plurality of content recommendation modes, a plurality of view modes, and at least one instruction for controlling presentation of the media content item.

In some embodiments, the function triggering module 730 includes a content loading module configured to, in response to detecting a selection operation for an operation option corresponding to a first content recommendation mode in the plurality of content recommendation modes, load a media content item presented in the content display page according to the first content recommendation mode.

In some embodiments, the apparatus 700 further includes an animation presenting module configured to: in accordance with the selected first content recommendation mode being a predetermined content recommendation mode, present an animation corresponding to the predetermined content recommendation mode in the content display page in response to detecting the selection for the operation option corresponding to the first content recommendation mode, the animation at least indicating a switching process from a current content recommendation mode to the first content recommendation mode.

In some embodiments, the apparatus 700 further includes a panel canceling module configured to: cancel presentation of the operation panel in the content display page in response to detecting the selection for the operation option corresponding to the first content recommendation mode.

In some embodiments, the function triggering module 730 includes a view presenting module configured to: present, in response to detecting a selection for an operation option corresponding to a first view mode in the plurality of view modes, the media content item in the content display page in the first view mode, while maintaining the presentation of the operation panel in the content display page.

In some embodiments, the at least one instruction includes at least one of the following: a content refresh instruction for the content display page, at least one playback control instruction for controlling playback of the media content item, or an instruction triggering voice instruction input.

In some embodiments, the content display page includes a homepage of an application.

FIG. 8 illustrates a block diagram of an electronic device 800 in which one or more embodiments of the present disclosure may be implemented. It should be understood that the electronic device 800 shown in FIG. 8 is only illustrative and should not constitute any limitation on the function and scope of the embodiments described herein. The electronic device 800 shown in FIG. 8 may be used to implement the terminal device 110 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor capable of performing various processes according to a program stored in the memory 820. In a multiprocessor system, a plurality of processing units executes computer-executable instructions in parallel to improve the parallel processing capabilities of electronic device 800.

The electronic device 800 typically includes a variety of computer storage media. Such media may be any available media that are accessible to the electronic device 800, including, but not limited to, volatile and non-volatile media, removable and non-removable media. The memory 820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium that can be used to store information and/or data (such as training data for training) and that can be accessed within the electronic device 800.

The electronic device 800 may further include an additional removable/non-removable, volatile/non-volatile storage medium. Although not shown in FIG. 8, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 820 may include a computer program product 828 having one or more program modules configured to execute various methods or actions of the various embodiments in the present disclosure.

The communication unit 840 is configured to communicate with other electronic devices through a communication medium. Additionally, the functionality of components of the electronic device 800 may be implemented by a single computing cluster or multiple computing machines capable of communicating through a communication connection. Thus, the electronic device 800 may operate in a networked environment using a logical connection with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed. The external device, such as a storage device, a display device, etc., communicates with one or more devices that enable users to interact with the electronic device 800, or communicates with any device (e.g., a network card, a modem, etc.) that enables the electronic device 800 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for page interaction, comprising:
presenting a content display page, the content display page at least presenting a media content item, and the content display page being enabled to be presented at least by selecting a predetermined navigation tab;
providing, in response to detecting a trigger for the navigation tab, an operation panel in the content display page, the operation panel comprising a plurality of operation options for triggering a plurality of types of service functions for the content display page, each type of service function having at least one operation option in the operation panel; and
triggering, in the content display page, a service function corresponding to the operation option in response to detecting a selection for an operation option among the plurality of operation options.

2. The method of claim 1, wherein providing the operation panel in the content display page comprises:
providing the operation panel in an active layer of the content display page, the media content item being presented in a background layer of the content display page.

3. The method of claim 2, wherein an overlay is superimposed on the media content item presented in the background layer of the content display page.

4. The method of claim 1, wherein the plurality of operation options at least corresponds to two or more of the following: a plurality of content recommendation modes, a plurality of view modes, and at least one instruction for controlling presentation of the media content item.

5. The method of claim 4, wherein triggering, in the content display page, the service function corresponding to the operation option comprises:
loading a media content item presented in the content display page according to a first content recommendation mode of the plurality of content recommendation modes, in response to detecting a selection operation for an operation option corresponding to the first content recommendation mode.

6. The method of claim 5, further comprising: in accordance with the selected first content recommendation mode being a predetermined content recommendation mode,
presenting an animation corresponding to the predetermined content recommendation mode in the content display page in response to detecting the selection for the operation option corresponding to the first content recommendation mode, the animation at least indicating a switching process from a current content recommendation mode to the first content recommendation mode.

7. The method of claim 5, further comprising:
canceling presentation of the operation panel in the content display page in response to detecting the selection for the operation option corresponding to the first content recommendation mode.

8. The method of claim 4, wherein triggering, in the content display page, the service function corresponding to the operation option comprises:
presenting the media content item in the content display page in a first view mode of the plurality of view modes in response to detecting a selection for an operation option corresponding to the first view mode, while maintaining the presentation of the operation panel in the content display page.

9. The method of claim 4, wherein the at least one instruction comprises at least one of:
a content refresh instruction for the content display page,
at least one playback control instruction for controlling playback of the media content item, or
an instruction triggering voice instruction input.

10. The method of claim 1, wherein the content display page comprises a homepage of an application.

11. (canceled)

12. An electronic device, comprising:
at least one processor; and
at least one memory coupled to the at least one processor and storing instructions executable by the at least one processor the instructions, when executed by the at least one processor causing the electronic device to perform acts comprising:
presenting a content display page, the content display page at least presenting a media content item, and the content display page being enabled to be presented at least by selecting a predetermined navigation tab;
providing, in response to detecting a trigger for the navigation tab, an operation panel in the content display page, the operation panel comprising a plurality of operation options for triggering a plurality of types of service functions for the content display page, each type of service function having at least one operation option in the operation panel; and
triggering, in the content display page, a service function corresponding to the operation option in response to detecting a selection for an operation option among the plurality of operation options.

13. non-transitory computer-readable storage medium having a computer program stored thereon, the computer program being executable by a processor to implement acts comprising:
presenting a content display page, the content display page at least presenting a media content item, and the content display page being enabled to be presented at least by selecting a predetermined navigation tab;
providing, in response to detecting a trigger for the navigation tab, an operation panel in the content display page, the operation panel comprising a plurality of operation options for triggering a plurality of types of service functions for the content display page, each type of service function having at least one operation option in the operation panel; and
triggering, in the content display page, a service function corresponding to the operation option in response to detecting a selection for an operation option among the plurality of operation options.

14. (canceled)

15. The electronic device of claim 12, wherein providing the operation panel in the content display page comprises:
providing the operation panel in an active layer of the content display page, the media content item being presented in a background layer of the content display page.

16. The electronic device of claim 15, wherein an overlay is superimposed on the media content item presented in the background layer of the content display page.

17. The electronic device of claim 12, wherein the plurality of operation options at least corresponds to two or more of the following: a plurality of content recommendation modes, a plurality of view modes, and at least one instruction for controlling presentation of the media content item.

18. The electronic device of claim 17, wherein triggering, in the content display page, the service function corresponding to the operation option comprises:
loading a media content item presented in the content display page according to a first content recommendation mode of the plurality of content recommendation modes, in response to detecting a selection operation for an operation option corresponding to the first content recommendation mode.

19. The electronic device of claim 18, wherein the acts further comprise: in accordance with the selected first content recommendation mode being a predetermined content recommendation mode,
presenting an animation corresponding to the predetermined content recommendation mode in the content display page in response to detecting the selection for the operation option corresponding to the first content recommendation mode, the animation at least indicating a switching process from a current content recommendation mode to the first content recommendation mode.

20. The electronic device of claim 18, wherein the acts further comprise:
canceling presentation of the operation panel in the content display page in response to detecting the selection for the operation option corresponding to the first content recommendation mode.

21. The electronic device of claim 17, wherein triggering, in the content display page, the service function corresponding to the operation option comprises:
presenting the media content item in the content display page in a first view mode of the plurality of view modes in response to detecting a selection for an operation option corresponding to the first view mode, while maintaining the presentation of the operation panel in the content display page.

22. The electronic device of claim 17, wherein the at least one instruction comprises at least one of:
a content refresh instruction for the content display page,
at least one playback control instruction for controlling playback of the media content item, or
an instruction triggering voice instruction input.
